(19) United States
(12) Patent Application Publication
(10) Pub. No.: US 2010/0066123 A1
(43) Pub. Date: Mar. 18, 2010

(54) TRAILER WHEEL FAIRINGS

(76) Inventors: Jason M. Ortega, Pacifica, CA (US); Kambiz Salari, Livermore, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(21) Appl. No.: 12/561,970

(22) Filed: Sep. 17, 2009

Related U.S. Application Data
(60) Provisional application No. 61/097,806, filed on Sep. 17, 2008.

(51) Int. Cl. B62D 35/00

(52) U.S. Cl. 296/180.4

(57) ABSTRACT

A wheel fairing and preferably a set of wheel fairings for reducing aerodynamic drag caused by the left-side and right side wheel sets of a rear wheel assembly supporting a trailer body at its rear end. The fairing body includes a tapered aerodynamic surface with a substantially U-shaped cross-section that tapers from a second end to a first end, and a base surface at the second end with a substantially same dimensional profile as one of the left-side or right-side wheel sets. Fasteners or other mounting devices secure each fairing body to an underside of the trailer body either upstream (as a nose fairing) or downstream (as a tail fairing) of the rear wheel assembly so that the second end is adjacent to an exposed rolling surface of the left-side or right side wheel set.

### CLAIM OF PRIORITY IN PROVISIONAL APPLICATION

This application claims priority in provisional application filed on Sep. 17, 2008, entitled “Drag Reduction of a Heavy Vehicle by Means of Trailer Wheel Fairings” Ser. No. 61/097,806, by Jason M. Ortega et al, and incorporated by reference herein.

### FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to aerodynamic drag reduction methods. The invention relates more particularly to a wheel fairing apparatus for reducing underbody drag of a vehicle that is produced by a rear wheel assembly (e.g. trailer wheels) supporting the vehicle at a rear end thereof.

### BACKGROUND OF THE INVENTION

It is well known in the art of vehicle design that the fuel consumption of a vehicle associated with its movement is directly related to certain aerodynamic characteristics of the vehicle, such as the aerodynamic drag of the vehicle expressed as the drag coefficient, C_{d}. As the aerodynamic drag experienced by a vehicle increases, the fuel costs also correspondingly increase due to the greater energy required to overcome the drag. For example, for a vehicle traveling 70 mph on a roadway, approximately 65% of the total fuel consumption of its engine is used to overcome aerodynamic drag. Thus, even a slight reduction in the aerodynamic drag coefficient of the vehicle can result in a significant improvement in fuel economy. This is especially true for bluff body vehicles, such as semi-trailer trucks (“semi's”) and other heavy vehicles having a tall and wide frontal profile, as well as a high ground clearance of the vehicle's underside due to the use of high profile wheels. FIG. 1 shows a conventional semi 10 having a tractor-trailer arrangement with a trailer 13 hitched to a tractor 11. The tractor 11 has a drive wheel assembly 12, and the trailer 13 is a semi-trailer type having a trailer body 14 with a rear end 16 supported by a rear wheel assembly 18 and a front end 15 (without a front axle) hitched to the tractor 11 above the tractor's drive wheel assembly 12. An underside of the trailer body is shown at 17 extending from the first end 15 to the rear end 16, and includes the underside area in front of and behind the rear wheel assembly 18.

One of the sources of aerodynamic drag on bluff body vehicles such as semis is underbody drag caused by airflow impinging upon and separating from the trailer's rear wheel assembly 18 at the rear end 16 of the semi-trailer body 14. In FIG. 1, airflow impingement on the rear wheel assembly 18 is shown at reference character 19, and flow separation from the rear wheel assembly produces a recirculation zone 20 directly behind it which reduces the base pressure and contributes to an increase in the overall vehicle drag. The recirculation zone 20 is particularly large for semis due to the high ground clearance of the trailer body and the large (tall and wide) cross-sectional area of the high profile/wide wheels of the rear wheel assembly. However, this problem also exists for other types of vehicles with high ground clearances.

Thus there is a need for an aerodynamic drag reduction apparatus which reduces underbody drag of a vehicle, especially bluff body heavy vehicles such as semis, caused by airflow impingement on and separation from the high profile/wide wheels of the rear wheel assembly supporting the rear end of the vehicle body.

### SUMMARY OF THE INVENTION

One aspect of the present invention includes a wheel fairing for use with one of a left-side wheel set or a right-side wheel set of a rear wheel assembly supporting a trailer body at a rear end thereof for reducing aerodynamic drag caused by the one wheel set, comprising: a fairing body having a longitudinal axis, first and second ends along the longitudinal axis, and a tapered aerodynamic surface extending between the first and second ends, said tapered aerodynamic surface having a substantially U-shaped cross-section that tapers from the second end to the first end and that has a width and height at the second end that is substantially equivalent to a width and height respectively of the one wheel set; and means for securing the fairing body to an underside of the trailer body so that the second end of the fairing body is adjacent to an exposed rolling surface of the one wheel set.

Another aspect of the present invention includes a wheel fairing set for reducing aerodynamic drag caused by each of the left-side and right side wheel sets of a rear wheel assembly supporting a trailer body at a rear end thereof, comprising: a pair of fairing bodies including left-side and right-side fairing bodies each having a longitudinal axis, first and second ends along the longitudinal axis, and a tapered aerodynamic surface extending between the first and second ends, said tapered aerodynamic surface having a substantially U-shaped cross-section that tapers from the second end to the first end and that has a width and height at the second end that is substantially equivalent to a width and height respectively of a corresponding one of the left-side and right-side wheel sets; and means for securing the pair of fairing bodies to an underside of and at the same longitudinal position along the trailer body, so that for each of the fairing bodies, the second end is adjacent to an exposed rolling surface of the corresponding to one of the left-side and right side wheel sets.

And another aspect of the present invention includes a wheel fairing set for reducing aerodynamic drag caused by each of the left-side and right side wheel sets of a rear wheel assembly supporting a trailer body at a rear end thereof, comprising: a first pair of nose fairing bodies including left-side and right-side nose fairing bodies each having a longitudinal axis, first and second ends along the longitudinal axis, a tapered aerodynamic surface extending between the first and second ends, said tapered aerodynamic surface having a substantially U-shaped cross-section that tapers from the second end to the first end and that has a width and height at the second end that is substantially equivalent to a width and height respectively of a corresponding one of the left-side and right-side wheel sets, and a base surface transversely connected to the tapered aerodynamic surface at the second end; means for securing the first pair of nose fairing bodies to an underside of the trailer body and upstream of the corresponding one of the left-side and right-side wheel sets, so that for each of the nose fairing bodies of the first pair, the second end is adjacent an exposed front-facing rolling surface of the corresponding to one of the left-side and right side wheel sets, so as to deflect airflow away from the exposed front-facing rolling surfaces of the left-side and right-side wheel sets and reduce the incident pressure thereon; a second pair of tail fairing bodies including left-side and right-side tail fairing bodies each having a longitudinal axis, first and second ends along the longitudinal axis, a tapered aerodynamic surface extending between the first and second ends, said tapered aerodynamic surface having a substantially U-shaped cross-section that tapers from the second end to the first end and that has a width and height at the second end that is substantially equivalent to a width and height respectively of a corresponding one of the left-side and right-side wheel sets, and a base surface transversely connected to the tapered aerodynamic surface at the second end; and means for securing the second pair of tail fairing bodies to an underside of the trailer body and downstream of the corresponding one of the left-side and right-side wheel sets, so that for each of the tail fairing bodies of the second pair, the second end is adjacent an exposed rear-facing rolling surface of the corresponding one of the left-side and right side wheel sets, so as to reduce the size of a recirculation zone formed under the trailer body immediately downstream of the corresponding one of the left-side and right-side wheel sets.

The present invention is directed to a wheel fairing apparatus and preferably a set of wheel fairings for reducing aerodynamic drag caused by the left-side and right side wheel sets of a rear wheel assembly supporting a trailer body at its rear end. The wheel fairing generally includes two main components: (1) a fairing body, and (2) means for securing the fairing body to an underside of the trailer body. The fairing body includes a tapered aerodynamic surface with a substantially U-shaped cross-section that tapers from a second end to a first end along a longitudinal axis. In particular, the width and height of the U-shaped cross-section at the second end is substantially equivalent to a width and height, respectively, of a corresponding one of the left-side and right-side wheel sets. The fairing body may be generally constructed from a rigid material, such as any variety of lightweight rigid plastics, sheet metals, fiberglass, other composites, etc. known in the art, and the tapered aerodynamic surface in particular may be constructed as a single continuously curved surface, or as multiple panel sections joined together.

The fairing body also may include a base surface that is transversely connected to the tapered aerodynamic surface at the second end and with a substantially same cross-sectional profile as one of the left-side or right-side wheel sets. And the means for securing the fairing body functions to secure each fairing body to an underside of the trailer body either upstream (as a nose fairing) or downstream (as a tail fairing) of one of the left-side or right-wide wheel sets of the rear wheel assembly so that the second end is adjacent to an exposed rolling surface of the left-side or right side wheel set. It is appreciated that the wheel fairing body may be optimized in various ways, such as by changing the length of the fairing body, by rounding and contouring its edges, etc., preferably using computational fluid dynamics (CFD) simulation methods.

When secured and used as a nose fairing and placed in a flow stream (i.e. when the semi travels forward), the tapered aerodynamic surface of the wheel fairing operates to deflect airflow away from the rolling surface of the corresponding one of the left-side or right side wheel sets to reduce the incident pressure thereon. And when secured and used as a tail fairing and placed in a flow stream, the tapered aerodynamic surface of the wheel fairing is designed to reduce the size of a recirculation zone formed under the trailer body immediately downstream of the corresponding one of the left-side and right-side wheel sets. And in addition to its drag reduction benefits, use of the wheel fairing apparatus and set of the present invention may also provide various operational advantages. For example, the fairing is completely passive such that it does not require any driver involvement for deployment or proper functioning. Therefore, once it is installed on the trailer, it does not require any further attention. Also the trailer underside location of the wheel fairings does not limit access to the trailer rear, which will allow shipping and receiving handlers to easily open and close the trailer cargo doors. It is appreciated that the term “wheel fairing” is used herein as a member, structure, or external surface of a vehicle whose primary function is to produce a smooth outline and to reduce aerodynamic drag caused by the wheels of the vehicle. And it is appreciated that the means for securing the fairing body can include various types of common mounting hardware such as but not limited to fasteners, bolts, nuts, screws, rivets, clamps, latches, hooks, ties, adhesives, magnets, etc. or other conventional and unconventional securing methods and devices known in the art for temporary or permanent securement.

It is also appreciated that while the conventional semi-trailer truck is used herein as a representative vehicle and an exemplary application to illustrate functionality and mounting arrangements of the present invention, the wheel fairing apparatus and set is generally for use with any vehicle having a rear wheel assembly with a frontal wheel profile that is exposed to direct airflow impingement due to a high ground clearance of the vehicle body. As such, and as used herein and in the claims, the term “trailer body” is defined to include any high ground clearance vehicle body supported by a rear wheel assembly at a rear or trailing end of the vehicle. The frontal wheel profile (surface area of a wheel as seen from the front) of the rear wheel assembly is typically very tall on such high ground clearance vehicles due to the use of large high profile tires, and also very wide due to the use of multiple wheels per side (left/right) per axle. It is also appreciated that rear wheel assemblies of conventional trailers may include one or more axles and supporting linkages, with each axle having one or more wheels positioned together on the left side of the trailer, and one or more wheels positioned on the right side of the trailer. As such, and as used herein and in the claims, “rear wheel assembly” includes all axles, wheels, tires, differentials, and other wheel/axle-related structures, such as struts, shocks, springs, control arms, linkages, etc. provided to support the rear end 16 of the trailer body and located below the underside thereof. Furthermore, as used herein and in the claims, the terms “left-side wheel set” and “right-side wheel set” are considered subsets of the rear wheel assembly, with each wheel set including all the wheels of the rear wheel assembly located on its respective side.

### BRIEF DESCRIPTION OF THE DRAWINGS

The accompanying drawings, which are incorporated into and form a part of the disclosure, are as follows:

FIG. 1 is side view of a conventional semi-trailer truck illustrating airflow impingement on a rear wheel assembly supporting the rear end of a trailer body, and the recirculation zone formed immediately downstream of the rear wheel assembly.

FIG. 2 is a side view of the conventional semi of FIG. 1 fitted with four units (two shown) of an exemplary embodiment of the wheel fairings of the present invention, including both nose fairings located immediately in front of the wheels of the rear wheel assembly and tail fairings located immediately behind the wheels of the rear wheel assembly.

FIG. 3 is an enlarged bottom view of the trailer, rear wheel assembly, and exemplary embodiment of the wheel fairings shown in FIG. 2.

FIG. 4 is a bottom view of one of the wheel fairings, i.e. a nose fairing 100, shown in FIG. 3.

FIG. 5 is a perspective view of the nose fairing 100 of FIG. 4.

FIG. 6 is a cross-sectional view of the nose fairing 100 taken along line 6-6 showing the U-shaped cross-section of the tapered aerodynamic surface near the first end.

FIG. 7 is a cross-sectional view of the nose fairing 100 taken along line 7-7 showing the U-shaped cross-section of the tapered aerodynamic surface near the second end.

FIG. 8 is a perspective view of another exemplary embodiment of the wheel fairing of the present invention having a curved base surface 122.

FIG. 9 is a bottom view of the wheel fairing of FIG. 8.

FIG. 10 is a side view of the conventional semi-trailer truck of FIG. 1 fitted with four units (two shown) of the wheel fairing of FIGS. 8 and 9.

### DETAILED DESCRIPTION

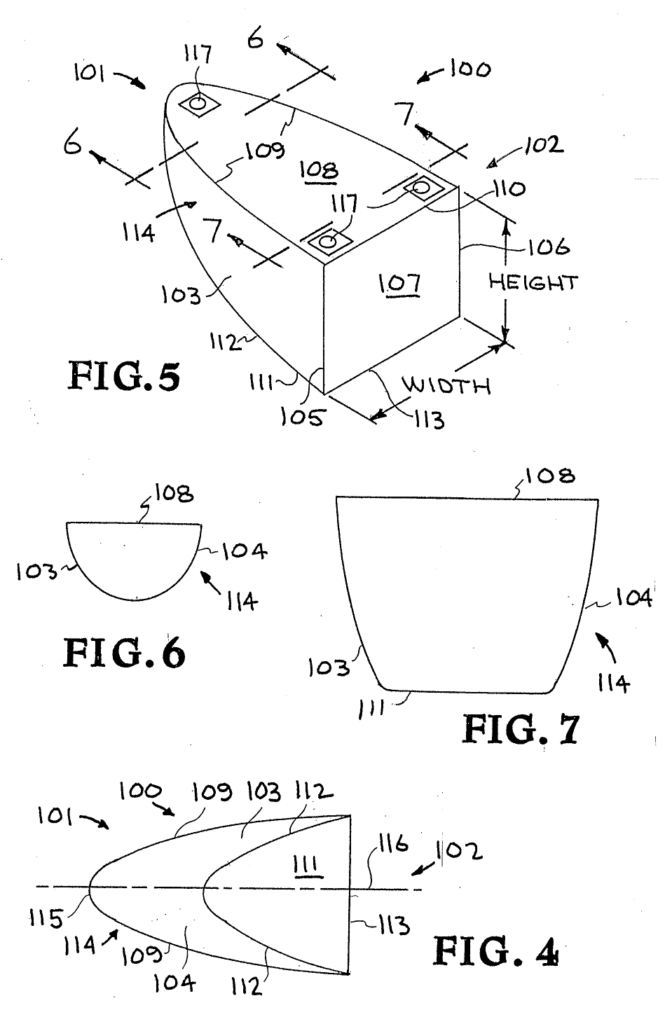

Turning now to the drawings, FIGS. 4-7 show detailed features of a first exemplary embodiment of the wheel fairing of the present invention, generally indicated at 100. The wheel fairing of the present invention includes a fairing body, and means for mounting the fairing body to an underside of a trailer body such as fasteners 117 in FIG. 4.

As can be seen in FIGS. 4 and 5, the fairing body has a streamlined shape extending from a first end 101 to a second end 102 along a longitudinal axis 116. The streamlined shape is provided by a tapered aerodynamic surface 114, shown having a bottom surface section 111 that is flanked by a first side surface section 103 and an opposing second side surface section 104 to form a substantially U-shaped cross-section. The first and second side surface sections 103, 104 are shown connected to the bottom surface section 111 along edge 112 shown as a parabolic curve, and are also shown having an upper rim 109 connected to an optional top surface section 108 (which is not part of the tapered aerodynamic surface). The first and second side surface sections 103, 104 are spaced apart from each other at the second end 102, but curve towards each other as they extend towards the first end 101, finally merging at the first end 101 at a blunt-nosed vertex 115. In addition to the tapered aerodynamic surface 114, a base surface 107 is also shown transversely connected to the tapered aerodynamic surface 114 at the second end 102. In particular, the base surface 107 is shown connected to the bottom surface section 111 along edge 113, to the first side surface section 103 along edge 105, to the second side surface section 104 along edge 106, and to the top surface section 108 along edge 110. The base surface 107 is preferably used when the wheel fairing is secured for use as a tail fairing, in order to prevent the wheel fairing from scooping air into the fairing cavity. It is appreciated that the connection of the bottom surface section 111, the first and second side surface sections 103, 104, and the base surface 107 may be either by attachment/joining of separate/discrete panel surfaces, or by the formation of a unitary body having integrally formed bottom and side surface sections of the tapered aerodynamic surface, as well as the base surface. And it is appreciated that the cavity formed by the tapered aerodynamic surface may be kept hollow or otherwise filled. When the optional top surface section 108 is not used, it is appreciated that the fasteners 117 or other means for securing may be positioned on one or more of the side surface sections 103, 104 and base surfaces 107. However, when provided, the upper surface section 108 is preferably flat so as to be mounted flush with the trailer underbody surface to enhance the drag reduction performance of the wheel fairing.

FIGS. 6 and 7 shows the substantially U-shaped cross-section formed by the bottom surface section 111 and the first and second side surface sections 103, 104 across the length of the fairing body along the longitudinal axis 116. In particular, FIG. 7 shows the fairing cross section taken along line 7-7 of FIG. 5, and FIG. 6 shows the fairing cross section taken along line 6-6 of FIG. 5. As can be seen, each of the fair cross-sections include a substantially U-shape formed by the bottom surface section 111 and the first and second side surface sections 103, 104, as well as an additional bar representing the top surface section 108 which caps and encloses the U-shape. Nonetheless, because the top surface section 108 is not considered a part of the tapered aerodynamic surface 114, the tapered aerodynamic surface 114 is characterized as having a U-shaped cross-section.

Furthermore, as illustrated by comparing FIGS. 6 and 7, the substantially U-shaped cross-section tapers as the tapered aerodynamic surface 114 convergingly extends from the second end 102 to the first end 101. The tapering (i.e. becoming progressively smaller and diminishing gradually toward one end) can be seen occurring in both height and width as the tapered aerodynamic surface 114 extends from the second end 102 to the first end 101. (It is notable that while both height and width are each shown as tapering in FIGS. 4-7, in the alternative only one dimension may be selected for tapering.) As such, the U-shaped cross-section at the second end 102 has the largest height and width (i.e. dimensional profile), and the U-shaped cross-section at the first end 101 has the smallest height and width. Therefore, the base surface 107 at the second end 102 is shown having a width and height that represents the largest dimensional profile of the fairing body. Furthermore, the width and height of the fairing body at the second end 102 is substantially equivalent to a width and height, respectively, of one of the left-side or right-side wheel sets. In contrast to the second end 102, the U-shaped cross-section at the first end is diminished at a blunt-nosed vertex 115. It is appreciated that the term “vertex” is used herein and in the claims to generally characterize the first end 101 as having a substantially reduced cross-section (when compared to the second 102) with a height and/or width that may be zero or near zero. As such the vertex 115, while shown as a rounded blunt-nose end, may alternatively have a sharp pointed terminous. The purpose and function of the taper of the tapered aerodynamic surface is different depending on how the wheel fairing is mounted on the underside of the trailer body, as will be discussed next.

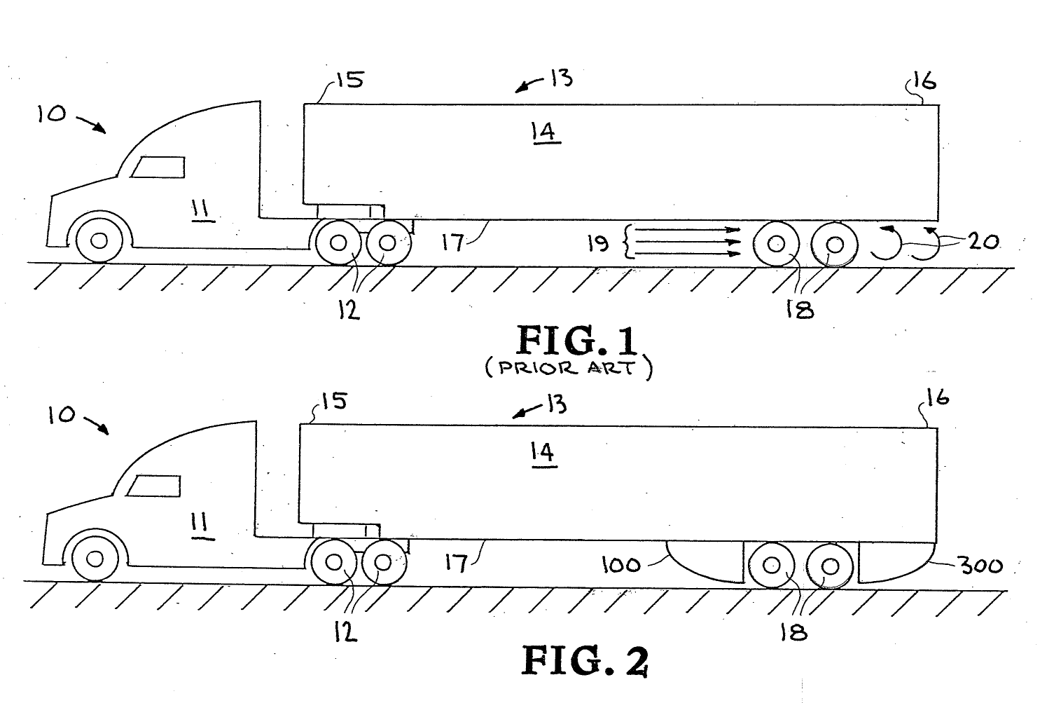

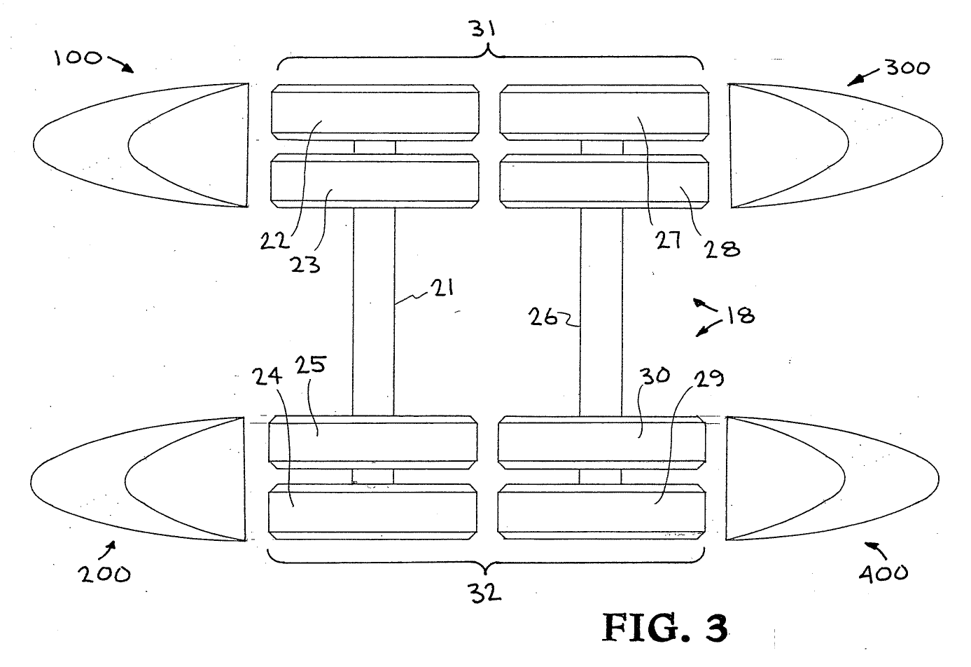

FIGS. 2 and 3 show the wheel fairing 100 of FIGS. 4-7 used together with similar wheel fairings 200, 300, and 400 in an exemplary set of four wheel fairings. In particular, FIGS. 2 and 3 show a conventional semi-trailer truck (such as described in FIG. 1) fitted with the four wheel fairings 100, 200, 300, and 400 on opposite sides of the rear wheel assembly 18 which support the rear end 16 of trailer body 14. Fairings 100 and 300 are positioned on opposite sides (upstream/downstream) of a left-side wheel set 31 and as such may be characterized as left-side fairings, and fairings 200 and 400 positioned on opposite sides (upstream/downstream) of a right-side wheel set 32 and as such may be characterized as right-side fairings. The left-side wheel set 31 includes wheels 22 and 23 from a first axle 21 as well as wheels 27 and 28 from a second axle 26, and the right-side wheel set 32 includes wheels 24 and 25 from the first axle 21 as well as wheels 29 and 30 from the second axle 26. Characterized another way, fairings 100 and 200 are positioned in front or upstream of the wheels of the rear wheel assembly 18 and as such are alternatively characterized as nose or upstream fairings, while fairings 300 and 400 are positioned behind or downstream of the wheels of the rear wheel assembly 18 and as such are alternatively characterized as tail or downstream fairings.

As shown in FIGS. 2 and 3, each of the wheel fairings 100-400 are secured to an underside 17 of the trailer body 14 so that the second end 102 with its larger dimensional profile, is positioned adjacent to an exposed rolling surface (i.e. wheel tread surface) of one of the left-side or right side wheel sets 31, 32. As shown in the figures, each left-side or right-side wheel set 31, 32 has an upstream exposed forward-facing rolling surface and a downstream exposed rear-facing rolling surface. By positioning the wheel fairings in this manner, the first end 101 of each fairing is consequently positioned either upstream or downstream of the wheel sets of the rear wheel assembly 18, to provide aerodynamic contour to the wheel sets. Furthermore, the longitudinal axis of each wheel fairing is preferably aligned with the corresponding one of the left-side or right side wheel sets in a travel path/direction of the wheel set, and the tapered aerodynamic surface at the first end slopes down and away from the underside of the trailer body in a direction of the first end. When the wheel fairing is secured upstream of the wheel set (i.e. as nose/upstream fairing), such as 100 and 200 in FIG. 3, the slope of the tapered aerodynamic surface forms a leading surface which functions to divert impinging airflow away from the exposed rolling surface of the wheel set. And when the wheel fairing is secured downstream of the wheel set (i.e. as tail/downstream fairing), such as 300 and 400 in FIG. 3, the slope of the tapered aerodynamic surface forms a trailing surface which functions to contour the separated flow to reduce base drag behind the wheel set.

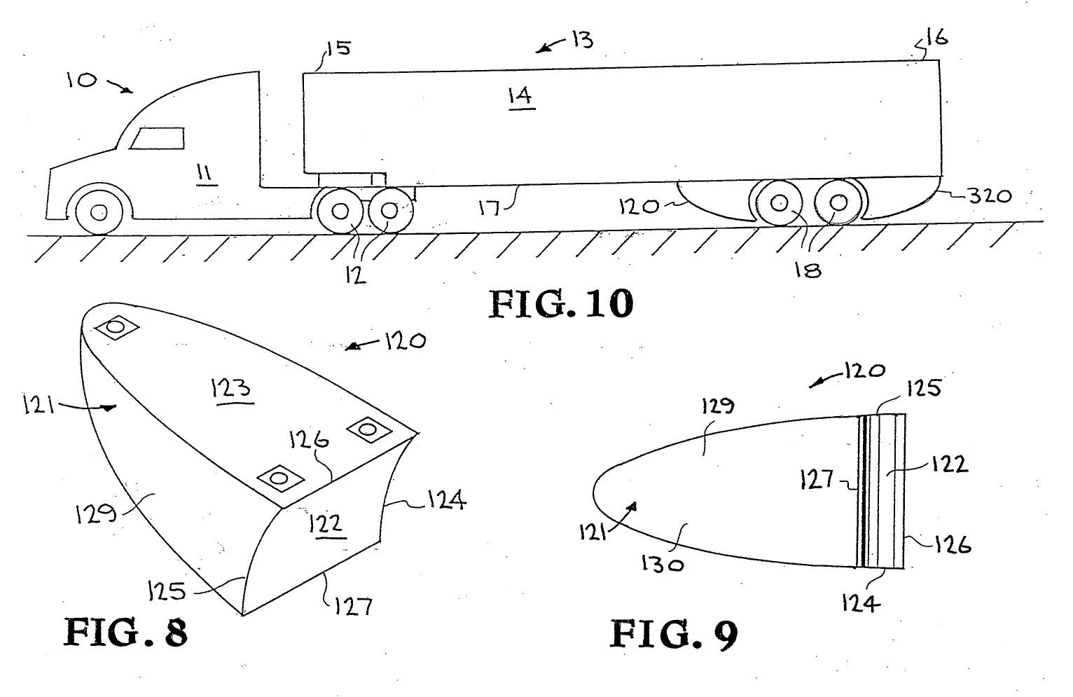

FIGS. 8-10 show a second exemplary embodiment of wheel fairing apparatus of the present invention, generally indicated at reference character 120. Similar to the first embodiment, the second embodiment also includes a fairing body, and means for mounting the fairing body to an underside of a trailer body. As can be seen in FIGS. 8 and 9, the fairing body has a streamlined shape provided by a tapered aerodynamic surface 121, shown as a substantially continuous curved body having a first side 129 and an opposite second side 130 which together form a substantially U-shaped cross-section without a discrete bottom surface section and side surface sections like in the first exemplary embodiment. A top section 123 is also shown provided connected to the tapered aerodynamic surface 121 along an upper rim thereof. The previous discussion of the U-shaped cross-section for the first exemplary embodiment 100 is also applicable here. However, transversely connected to the tapered aerodynamic surface 121, is a curved base surface 122 that is connected to the top section 123 along edge 126, to the first side 129 along edge 125, and to the second side 130 along edge 124, and to a lower part of both first and second side sections 129, 130 along edge 127. In particular, the base surface is curved to substantially follow the contour of the exposed rolling surface of one of the left-side or right-side wheel sets, as shown in FIG. 10, which may further enhance drag reduction by reducing the gap space between the rolling surfaces and the second ends of the wheel fairings.

While particular embodiments and parameters have been described and/or illustrated, such are not intended to be limiting. Modifications and changes may become apparent to those skilled in the art, and it is intended that the invention be limited only by the scope of the appended claims.

We claim:

1. A wheel fairing for use with one of a left-side wheel set or a right-side wheel set of a rear wheel assembly supporting a trailer body at a rear end thereof for reducing aerodynamic drag caused by the one wheel set, comprising:
a fairing body having a longitudinal axis, first and second ends along the longitudinal axis, and a tapered aerodynamic surface extending between the first and second ends, said tapered aerodynamic surface having a substantially U-shaped cross-section that tapers from the second end to the first end and that has a width and height at the second end that is substantially equivalent to a width and height respectively of the one wheel set; and
means for securing the fairing body to an underside of the trailer body so that the second end of the fairing body is adjacent to an exposed rolling surface of the one wheel set.

2. The wheel fairing of claim 1,
wherein the fairing body includes a base surface transversely connected to the tapered aerodynamic surface at the second end.

3. The wheel fairing of claim 2,
wherein the base surface is curved to substantially follow the contour of the rolling surface of the one wheel set.

4. The wheel fairing of claim 1,
wherein said means for securing the fairing body is adapted to secure the fairing body upstream of the one wheel set so as to deflect airflow away from the rolling surface of the one wheel set and reduce the incident pressure thereon.

5. The wheel fairing of claim 1,
wherein said means for securing the fairing body is adapted to secure the fairing body downstream of the one wheel set so as to reduce the size of a recirculation zone formed under the trailer body immediately downstream of the one wheel set.

6. A wheel fairing set for reducing aerodynamic drag caused by each of the left-side and right side wheel sets of a rear wheel assembly supporting a trailer body at a rear end thereof, comprising:
a pair of fairing bodies including left-side and right-side fairing bodies each having a longitudinal axis, first and second ends along the longitudinal axis, and a tapered aerodynamic surface extending between the first and second ends, said tapered aerodynamic surface having a substantially U-shaped cross-section that tapers from the second end to the first end and that has a width and height at the second end that is substantially equivalent to a width and height respectively of a corresponding one of the left-side and right-side wheel sets; and
means for securing the pair of fairing bodies to an underside of and at the same longitudinal position along the trailer body, so that for each of the fairing bodies, the second end is adjacent to an exposed rolling surface of the corresponding to one of the left-side and right side wheel sets.

7. The wheel fairing set of claim 6,
wherein each of the fairing bodies includes a base surface transversely connected to the tapered aerodynamic surface at the second end.

8. The wheel fairing set of claim 7,
wherein the base surface is curved to substantially follow the contour of the rolling surface of the corresponding one of the left-side and right-side wheel sets.

9. The wheel fairing set of claim 6,
wherein said means for securing the pair of fairing bodies is adapted to secure each fairing body upstream of the corresponding one of the left-side and right-side wheel sets so as to deflect airflow away from the rolling surface thereof and reduce the incident pressure thereon.

10. The wheel fairing set of claim 6,
wherein said means for securing the pair of fairing bodies is adapted to secure each fairing body downstream of the corresponding one of the left-side and right-side wheel sets so as to reduce the size of a recirculation zone formed under the trailer body immediately downstream of the corresponding one of the left-side and right-side wheel sets.

11. The wheel fairing set of claim 6, further comprising:
a second pair of fairing bodies including left-side and right-side fairing bodies each having a longitudinal axis, first and second ends along the longitudinal axis, and a tapered aerodynamic surface extending between the first and second ends, said tapered aerodynamic surface having a substantially U-shaped cross-section that tapers from the second end to the first end and that has a width and height at the second end that is substantially equivalent to a width and height respectively of a corresponding one of the left-side and right-side wheel sets; and
means for securing the second pair of fairing bodies to an underside of and at the same longitudinal position along the trailer body and at an opposite side of the rear wheel assembly from that of the first pair of fairing bodies, so that for each of the fairing bodies of the second pair, the second end is adjacent to an exposed rolling surface of the corresponding one of the left-side and right side wheel sets.

12. A wheel fairing set for reducing aerodynamic drag caused by each of the left-side and right side wheel sets of a rear wheel assembly supporting a trailer body at a rear end thereof, comprising:
a first pair of nose fairing bodies including left-side and right-side nose fairing bodies each having a longitudinal axis, first and second ends along the longitudinal axis, a tapered aerodynamic surface extending between the first and second ends, said tapered aerodynamic surface having a substantially U-shaped cross-section that tapers from the second end to the first end and that has a width and height at the second end that is substantially equivalent to a width and height respectively of a corresponding one of the left-side and right-side wheel sets, and a base surface transversely connected to the tapered aerodynamic surface at the second end;
means for securing the first pair of nose fairing bodies to an underside of the trailer body and upstream of the corresponding one of the left-side and right-side wheel sets, so that for each of the nose fairing bodies of the first pair, the second end is adjacent an exposed front-facing rolling surface of the corresponding to one of the left-side and right side wheel sets, so as to deflect airflow away from the exposed front-facing rolling surfaces of the left-side and right-side wheel sets and reduce the incident pressure thereon;
a second pair of tail fairing bodies including left-side and right-side tail fairing bodies each having a longitudinal axis, first and second ends along the longitudinal axis, a tapered aerodynamic surface extending between the first and second ends, said tapered aerodynamic surface having a substantially U-shaped cross-section that tapers from the second end to the first end and that has a width and height at the second end that is substantially equivalent to a width and height respectively of a corresponding one of the left-side and right-side wheel sets, and a base surface transversely connected to the tapered aerodynamic surface at the second end; and
means for securing the second pair of tail fairing bodies to an underside of the trailer body and downstream of the corresponding one of the left-side and right-side wheel sets, so that for each of the tail fairing bodies of the second pair, the second end is adjacent an exposed rear-facing rolling surface of the corresponding one of the left-side and right side wheel sets, so as to reduce the size of a recirculation zone formed under the trailer body immediately downstream of the corresponding one of the left-side and right-side wheel sets.

13. The wheel fairing set of claim 12,
wherein each of the base surfaces is curved to substantially follow the contour of the rolling surface of the corresponding one of the left-side and right-side wheel sets.
